(19) United States
(12) Patent Application Publication
(10) Pub. No.: US 2006/0080976 A1
(43) Pub. Date: Apr. 20, 2006

(54) Method for the estimation of the power consumed by the compressor of a refrigerant circuit in a motor vehicle

(76) Inventors: Markus Markowitz, Koeln (DE); Nick Crisp, Leigh-on-Sea (GB); Jonathan Willey, Great Baddow (GB)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 11/249,614

(22) Filed: Oct. 13, 2005

(30) Foreign Application Priority Data
Oct. 14, 2004 (EP) 04105059.2

(51) Int. Cl. G01K 13/00

(52) U.S. Cl. 62/129

(57) ABSTRACT

The invention relates to a refrigerant system for a motor vehicle comprising a compressor, a condenser and an evaporator. A pressure sensor measures the discharge pressure at the outlet of the compressor, and a temperature sensor measures the ambient temperature at the condenser. Based on the measured values of pressure and temperature, a controller) estimates the power consumption of the compressor. Said estimation may then be used to control the power generation of the engine accordingly.

### FIELD OF THE INVENTION

The invention relates to method for the estimation of the power consumed by the compressor of a refrigerant system in a motor vehicle, and more particularly to a system and a method for estimating the power based on a temperature of the condenser and a pressure the compressor and the expansion device in the refrigerant system.

### BACKGROUND AND SUMMARY OF THE INVENTION

An increasing number of motor vehicles is equipped with an air conditioning system that comprises a refrigerant circuit with a compressor, an evaporator and a condenser. The power consumed by such a circuit, particularly by its compressor, has to be provided by the engine of the vehicle. For an optimal control of said engine with respect to fuel consumption, emissions and performance it is therefore desirable to know the power consumption of the refrigerant circuit in advance. This is particularly true for refrigerant circuits with variable capacity in which the demanded power may vary largely. For this reason, it is proposed in EP 915 767 B1 to estimate the power consumption of the compressor of a refrigerant circuit based on measured values for the discharge pressure at the outlet of the compressor, the speed of the compressor and the flow rate in the evaporator. The determination of the flow rate requires however special sensor equipment, especially if a manual control system is used. A climate control module could give a data feedback, for example by selection of blower speed for estimation of the evaporator air flow, but this requires additional efforts on electric and mechanical hardware.

The method provided by the present invention allows estimating the power consumed by the compressor of a refrigerant circuit in a motor vehicle, wherein said refrigerant circuit comprises in the direction of the flow of the refrigerant (at least) an evaporator, said compressor and a condenser. As usual, the refrigerant (for example chlorofluorohydrocarbon or tetrafluoroethane) is evaporated in the evaporator while taking up heat from air that has to be cooled, and said evaporated refrigerant is then compressed by the compressor and condensed in the condenser while rejecting its heat to a coolant (typically ambient air).

The method includes determining the ambient temperature of the condenser, i.e. the entrance temperature of the aforementioned coolant to which heat is transferred in the condenser. Said ambient temperature may be inferred from other values or it may be measured by a temperature sensor disposed in the vicinity of the condenser. Moreover, the ambient temperature at the condenser is preferably approximated by the ambient temperature of the vehicle which may be measured a distance away from the condenser. Further, the discharge pressure of the compressor is determined, whereby the discharge pressure can be measured everywhere between the outlet of the compressor and the expansion device. That means package requirements could be taken into account advantageously when locating the pressure sensor. E.g. the sensor could be located at the inlet, at the outlet, or on the condenser itself. The pressure drop at the refrigerant side of the condenser is relatively small and can be taken into account when calibrating the specific refrigerant circuit, e.g. with a heat transfer effectiveness correction. The power consumed by the compressor is estimated based on the aforementioned ambient temperature and the aforementioned discharge pressure. Said estimation preferably relies on experimentally determined relations that may for example be stored in a lookup-table. The estimation process can therefore be adapted to each vehicle type or even each individual vehicle.

The method described above is particularly suited for low cost vehicles because it can readily be implemented and merely requires the measurement of the discharge pressure at the outlet of the compressor and an ambient temperature. In many cases, these parameters are already available in the control system of a motor vehicle because they are needed for other purposes, too, making additional hardware unnecessary. Moreover, said two parameters allow a surprisingly precise estimation of the consumed power of the compressor which even proves to be better than the results of more complicated methods.

While the discharge pressure of the compressor may optionally be inferred from other parameters, it is preferably directly measured by a pressure sensor that is disposed in the refrigerant circuit somewhere between compressor and condenser, a section in which there is an approximately constant pressure.

In a preferred embodiment of the invention, the vapour pressure of the refrigerant that corresponds to the ambient temperature at the condenser is determined, said vapour pressure being called “reference pressure” in the following. This reference pressure may for example be read from a lookup-table for the particular refrigerant that is used.

According to a further development of the aforementioned embodiment, a “difference pressure” is next calculated as a difference between the discharge pressure at the outlet of the compressor and the aforementioned reference pressure. Said difference pressure may optionally be corrected based on the condenser heat transfer effectiveness.

The heat transfer effectiveness term describes the performance of the condenser by characterising the heat transfer in the heat exchanger: How much higher are both actual condensing temperature and condensing pressure in comparison to the ambient conditions to reject a certain amount of heat? With a value table for different conditions an adjustment term can be generated, which can be taken into account for different condenser installations.

In a further step, the aforementioned difference pressure or its corrected value may be used as an input for a lookup-table that yields as output the power consumed by the compressor, i.e. the value which is looked for. Said lookup-table may for example be obtained experimentally for each type of (or even for each individual) motor vehicle and/or refrigerant circuit.

According to a further development of the method, the torque demanded by the compressor is determined, too. This determination is typically based on the estimated consumed power and the (rotational) speed of the compressor. As the compressor is usually driven by the engine of the vehicle, the speed of the compressor has a fixed relation to the speed of the engine which is generally already known. Therefore, no additional equipment will be required for the determination of the speed of the compressor.

Optionally a transient term is added to the estimated consumed power during a limited time after a start of the compressor. Said limited time may for example last from about 1 s to about 30 s, preferably from 6 s to 10 s. The additional term can compensate for transient effects according to the starting characteristics of the compressor.

The estimated value for the power consumed by the compressor of the refrigerant circuit may be used for various purposes. Preferably it is used for the control of the power generation of the engine of the vehicle such that it may remain close to optimum with respect to fuel consumption, emissions, idle stability, cruise smoothness and performance.

The above advantages and other advantages, and features of the present invention will be readily apparent from the following detailed description of the preferred embodiments when taken in connection with the accompanying drawings, and from the claims.

### BRIEF DESCRIPTION OF THE DRAWINGS

The objects and advantages described herein will be more fully understood by reading an example of an embodiment in which the invention is used to advantage, referred to herein as the Description of Preferred Embodiment, with reference to the drawings, wherein:

FIG. 1 is a schematic diagram of a refrigerant circuit according to the present invention;

FIG. 2 is a diagram showing measured torques of a compressor and the torque predicted by a method according to the present invention.

### DESCRIPTION OF PREFERRED EMBODIMENT(S)

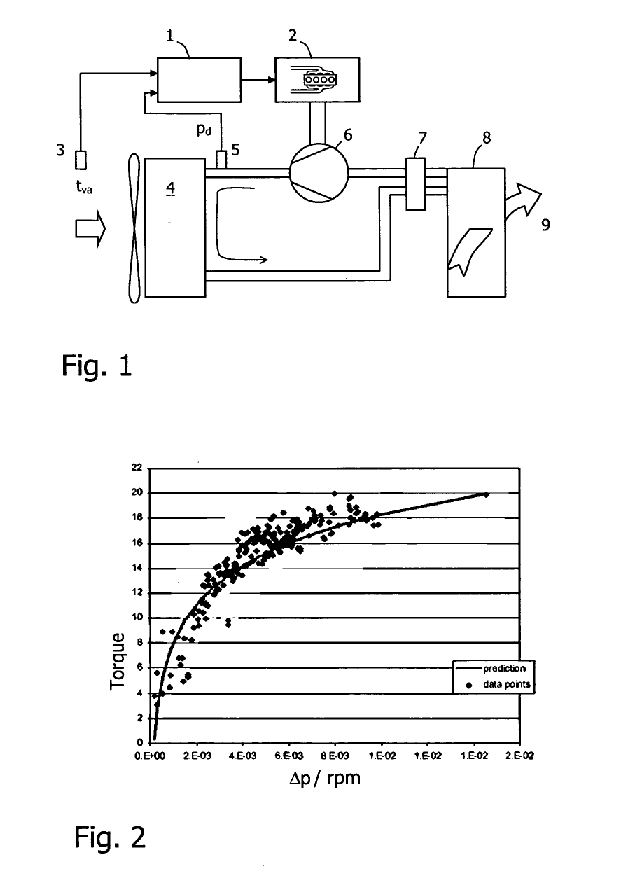

FIG. 1 shows schematically a typical refrigerant system that is used in a motor vehicle for air conditioning. The refrigerant system includes the following components:
An evaporator 8 that is placed in the heating/ventilation/air conditioning (HVAC) unit (not shown) and cools air 9, which is taken from inside or outside the vehicle's cabin and then directed into the cabin to provide cooling, while the refrigerant of the circuit is evaporated.
An expansion device 7 for regulating the refrigerant pressure at the outlet of the evaporator.
A compressor 6 for compressing the evaporated refrigerant that enters the compressor 6 at its suction side and leaves it at the discharge pressure p_{d} on the compression side. The compressor 6 is mechanically coupled to the internal combustion engine 2 of the vehicle for obtaining power from there.
A condenser 4 in which the evaporated refrigerant is condensed while rejecting heat to ambient air that is typically blown through the condenser 4 by a fan. The condensed refrigerant then returns via the expansion device 7 to the evaporator 8 to complete the cycle.

The refrigerant system typically comprises additional components, e.g. a refrigerant storage accumulator/receiver, which are not shown in the figures.

FIG. 1 further shows a temperature sensor 3 that is adapted to measure the ambient temperature of the condenser 4 or of the vehicle. The sensor 3 is usually disposed in the area of the inner side of the front bumper or behind that. If such a sensor should not be available, the ambient temperature can also be determined based on the inlet air temperature of the engine that is normally available to the motor control unit (so-called “inferred ambient temperature”). Moreover, a combination of both values (ambient air temperature and inlet air temperature) can be employed in order to achieve a better estimation of the temperature of the air flowing into the condenser.

FIG. 1 further shows a pressure sensor 5 disposed in the line between compressor 6 and condenser 4 to sense the discharge pressure p_{d} of the compressor outlet. The sensor 5 could also be located between condenser 6 and expansion device 7. Both sensors 3, 5 are coupled to a (powertrain) control module 1 that controls the engine 2. Said control module 1 may be implemented e.g. by a microprocessor with usual components (CPU, storage, I/O interfaces etc.) and appropriate software.

In the system described above, the present invention relates to an algorithm to determine the momentary torque requirement of the air conditioning (AC) compressor 6 that is driven by the engine 2 of the motor vehicle. The vehicle's powertrain control module 1 is thus enabled to take into account the AC compressor torque demand when changing engine speed or engine load according to driver demands, as well as to compensate the compressor torque demand when engaging or disengaging the compressor 6. These aspects are explained in more detail in the following.

The compressor 6 of the automotive air conditioning takes torque from the engine 2 to provide refrigerating capacity to the evaporator 8 and thereby cabin cooling to the vehicle's occupants. The required torque can be significant in hot climate conditions, when high cabin cooling demands have to be satisfied. On the other hand, the torque requirements are low when the AC system is running at low load, e.g. for de-humidification in wet/cool conditions. Therefore, the required torque to drive the AC compressor 6 varies greatly with the operating conditions of the AC system and specifically with climatic conditions. Influence parameters are e.g. ambient temperature and humidity, solar heat load, momentary cabin temperature, vehicle speed, settings of the HVAC controls, i.e. blower speed, re-circulated or fresh air intake etc.

It is important to accurately determine/predict the AC compressor torque demand because inaccurate values would lead to inappropriate load compensation and thereby deteriorated driveability as well as the risk of engine stalls or engine speed hang-ups on return to idle when stopping the vehicle.

A precise torque estimation improves fuel economy and/or optimizes emissions primarily because the torque reserve at idle is not required. Load compensation for AC is not required as torque estimation is more precisely with the presented method. Each uncompensated or poorly modelled accessory torque leads to a need for torque reserve to compensate. At idle spark retard equates to wasted fuel. Good idle/cruise load rejection leads to smoother air and spark control. Smoothness allows for better fuel control, which is an emissions benefit.

For accurate prediction (calculation) of the compressor torque demand (or power demand respectively) the refrigerant mass flow, the refrigerant enthalpy change at the compressor, and the compressor isentropic efficiency map must be known. The refrigerant mass flow is the primary difficulty. For a fixed capacity compressor, it could be calculated using the compressor's nominal capacity, the volumetric efficiency map and compressor speed—however, the refrigerant density or suction pressure needs to be also known for this. Unfortunately, in the case of a variable capacity compressor, there is no external indication of the percentage capacity the compressor is running on. Once the suction pressure is approaching the control pressure, the compressor control valve adjusts the compressor capacity to maintain this pressure and thereby evaporator temperature. The enthalpy change of the refrigerant caused by the compressor can be calculated using refrigerant pressure on compressor suction and discharge ports.

Estimation of the compressor torque demand is still possible based on compressor discharge pressure. The estimation accuracy of this approach is often limited, however, because of the fact that said discharge pressure itself is no direct indication for the load on the AC system, or the amount of cooling capacity provided to the vehicle's cabin. Low load on the AC system with the condenser exposed to a high ambient air temperature can result in the same discharge pressure value as high AC load at low ambient temperature. Therefore, additional data that characterise the suction side, i.e. evaporator airflow amount, evaporator temperature, or suction pressure etc. are often utilised to improve the estimation accuracy. However, sensors or an electronic HVAC control module must be available to provide this data.

In vehicles with a cost-efficient HVAC system, consisting of e.g. a clutch cycling orifice tube (CCOT) refrigerant circuit or a so-called TXV system and manually operated HVAC unit, no data is available from the suction side of the refrigerant circuit, unless sensors are fitted specifically for this purpose. The present invention solves this problem and provides an accurate estimation of compressor torque for these HVAC systems, too.

According to the basic system balance equation, the heat rejected by the AC condenser 4 equals the heat taken in from the evaporator 8 (evaporating capacity) plus the enthalpy change of the refrigerant generated by the compressor 4, or the compressor work respectively. The relation of evaporating capacity to compressor work is the effectiveness of the process, or the coefficient of performance (COP). Therefore, the compressor power can be calculated from the heat flux rejected by the condenser and the COP. Also, the COP correlates well to the compressor work. Hence, the compressor power correlates to the condenser heat rejection.

The condenser heat rejection can be derived from the difference of the actual condensing pressure (compressor discharge pressure) p_{d} and the vapour pressure pᵥₐ that a liquid/vapour refrigerant mix would have at the temperature tᵥₐ of the air entering the condenser 4. This “difference pressure” or pressure excess fraction Δp_{de}, optionally corrected by an assumption for the condenser heat transfer effectiveness p_{de,corr}, strongly correlates to the heat rejected by the condenser 4 (if no such correction is made, p_{de,corr}=p_{de} is assumed in the following).

Therefore, the compressor power has a strong correlation to the corrected compressor discharge pressure excess fraction Δp_{de,corr}, i.e. the corrected compressor discharge pressure excess fraction is a very good means of estimating the compressor power demand. The compressor torque can then easily be calculated from the estimated compressor power with the compressor speed (which is proportional to engine speed). Hence, the compressor torque correlates to Δp_{de,corr} divided by engine speed.

In summary, the refrigerant system and the method according to the invention are characterized by the following features (which may be considered alone or in combination):
A temperature sensor 3 fitted to the vehicle that measures the outside air temperature, or ambient air temperature tᵥₐ and thereby the temperature of the air approaching the AC condenser, which is used to calculate the refrigerant vapour pressure pᵥₐ by using a function or a lookup-table containing the refrigerant properties (vapour pressure=f(temperature tᵥₐ)).
A pressure sensor 5 on the outlet side of the vehicle's refrigerant circuit to measure the refrigerant discharge pressure p_{d}, and calculation of the discharge pressure excess fraction or difference pressure Δp_{de}=p_{d}−pᵥₐ.
Correction of the difference pressure Δp_{de} to account for the condenser heat transfer effectiveness, Δp_{de,corr} (optional).
A lookup table or a function defining the relationship between compressor power or compressor torque (using engine speed) and difference pressure Δp_{de} or corrected difference pressure Δp_{de,corr}.
The calculated compressor torque demand is updated continually for all engine speeds.
The calculated compressor torque is used to stabilise the engine 2 on return to idle, e.g. de-clutch and stop the vehicle.
The calculated compressor torque is used to stabilise the engine 2 during compressor engagements, especially when the compressor has not been disengaged long enough for the refrigerant pressure to equalise on suction and discharge sides of the refrigerant circuit.
The calculated compressor torque is used to stabilise the engine 2 during compressor disengagements, to prevent the engine speed from decreasing or increasing during the disengagement.
The calculated compressor torque is used to stabilise the engine during AC clutch cycling e.g. with a fixed capacity compressor.

During the start of the compressor, torque phenomena occur due to the inertia of the compressor and due to the pressure build-up in the refrigerant system, i.e. due to the starting characteristics of the compressor. In order to deal with these effects, a special transient term can be provided for the first 6-10 s of the starting of the compressor. Said transient term can be calibrated into tables of the motor control logic and shows a dependency on the engine speed, the time since start of the compressor and the corrected discharge pressure excess fraction. The transient term plays a role only during switching-on of the compressor. During switching-off of the compressor, during changes of the engine speed, during disengagement of the gear (“return to idle”) or the like only the fixed term described above is applied.

The compressor torque calculation is preferably carried out continuously during engine run with an update rate of e.g. 50 ms.

FIG. 2 shows in a diagram the torque demand of a compressor in dependence on the corrected difference pressure Δp_{de,corr} divided by the compressor speed. It can be seen that the curve that was calculated according to the present invention provides a very accurate prediction function for the actual data.

This concludes the description of the invention. The reading of it by those skilled in the art would bring to mind many alterations and modifications without departing from the spirit and the scope of the invention. Accordingly, it is intended that the scope of the invention be defined by the following claims:

1. A method for the estimation of the power consumed by a compressor of a refrigerant system in a motor vehicle, the system including an evaporator, a compressor, an expansion device coupled between the evaporator and the compressor, the system further including a condenser, the method comprising:
determining a temperature of the condenser;
determining a discharge pressure between the compressor and the expansion device; and
estimating a power consumed by the compressor based on said temperature and discharge pressure.

2. The method according to claim 1 wherein said condenser temperature is substantially an ambient temperature of the motor vehicle.

3. The method according to one of claim 2, further comprising a determination of a reference pressure corresponding to the ambient temperature.

4. The method according to claim 3, further comprising calculating a difference between said discharge pressure and said reference pressure.

5. The method according to claim 4, further comprising correcting said calculated pressure difference based on a condenser heat transfer effectiveness.

6. The method according to claim 5 further comprising determining a power consumed by the compressor based on said corrected calculated pressure difference.

7. The method according to claims 6 further comprising determining a torque demanded by said compressor based on said consumed power and a speed of said compressor.

8. A refrigerant system for a motor vehicle, comprising
a compressor for compressing a refrigerant, said compressor driven by the engine of the vehicle;
a condenser disposed downstream of said compressor for condensing the refrigerant and for rejecting heat;
an evaporator disposed downstream of the condenser for evaporating the condensed refrigerant and for extracting heat from a medium to be cooled;
a temperature sensor for measuring ambient temperature;
a pressure sensor for measuring a discharge pressure of said compressor;
a controller coupled to said temperature sensor and said pressure sensor, said controller calculating a torque demanded by said compressor based on a signal from said temperature sensor and a signal from said pressure sensor.
